(19) United States
(12) Patent Application Publication
(10) Pub. No.: US 2015/0174557 A1
(43) Pub. Date: Jun. 25, 2015

(54) PURIFICATION CATALYST

(71) Applicant: DENSO CORPORATION, Kariya-city (JP)

(72) Inventors: HIROAKI YOTOU, Kariya-city (JP); MASAKI YOSHINAGA, Nisshin-city (JP); GOH IIJIMA, Nisshin-city (JP); YOSHIMASA HIJIKATA, Miyoshi-city (JP)

(21) Appl. No.: 14/573,376

(22) Filed: Dec. 17, 2014

(30) Foreign Application Priority Data
Dec. 24, 2013 (JP) 2013-265615

(51) Int. Cl. B01J 27/135

(52) U.S. Cl. CPC B01J 27/135

(57) ABSTRACT

A purification catalyst that purifies nitric acid is provided in the present disclosure. The purification catalyst includes a catalyst particle, an inorganic acid, and water. The catalyst particle includes a metal oxide that has a function of an n-type semiconductor. The purification catalyst purifies the nitric acid under at least one of a light irradiation condition and a heating condition.

### CROSS REFERENCE TO RELATED APPLICATION

This application is based on Japanese Patent Application No. 2013-265615 filed on Dec. 24, 2013, the disclosure of which is incorporated herein by reference.

### TECHNICAL FIELD

The present disclosure relates to a purification catalyst purifying nitric acid.

### BACKGROUND

Patent Literature 1: WO 2011/027864 A1 (corresponding to US 2012/0228120 A1)

Nitric acid may be generated when nitrogen oxide emitted from a vehicle, a boiler, or the like to an atmosphere melts into groundwater. In addition, the nitric acid may be generated from ammonia, which is used as a fertilizer, for example. At a factory or the like, wastewater containing the nitric acid may be produced.

The nitric acid may have an adverse effect to the body. Therefore, a regulation value is determined with respect to the amount of the nitric acid contained in well water and tap water. Conventionally, a technology by which hydrogen is generated in the nitric acid using a photocatalyst and the nitric acid is purified by the hydrogen is disclosed (referring to Patent literature 1).

The applicants of the present disclosure have found the following. A technology purifying the nitric acid may be required. In the conventional purifying method, a relatively large amount of the ammonia may be generated as a byproduct in accompany with a purification of the nitric acid. The ammonia is also a harmful substance for the body. Therefore, a purification method with the conventional purification catalyst may be inadequate for purifying the nitric acid.

### SUMMARY

It is an object of the present disclosure to provide a purification catalyst preventing a generation of the ammonia and sufficiently purifying the nitric acid.

According to one aspect of the present disclosure, a purification catalyst that purifies nitric acid is provided. The purification catalyst includes a catalyst particle, an inorganic acid, and water. The catalyst particle includes a metal oxide that has a function of an n-type semiconductor. The purification catalyst purifies the nitric acid under at least one of a light irradiation condition and a heating condition.

According to the purification catalyst, atomic hydrogen is generated by the activated catalyst particle and the inorganic acid. The nitric acid is reduced by the atomic hydrogen so that nitrogen gas is generated. Accordingly, it is possible that the purification catalyst purifies the nitric acid. Furthermore, the hydrogen atom in the inorganic acid, which has been consumed by a reduction of the nitric acid, is filled by a proton in water.

According to the purification catalyst in the present disclosure, it may be possible that the purification catalyst purifies the nitric acid at a high purification rate under at least one of the light irradiation condition and the heating condition.

It is possible that the purification catalyst prevents generation of the ammonia at the time of the purification of the nitric acid.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a drawing schematically illustrating a purification catalyst in a first example;

FIG. 2 is a drawing illustrating a purification method of nitric acid in the first example;

FIG. 3 is a drawing schematically illustrating a purification catalyst in a second example;

FIG. 4 is a drawing illustrating a mechanism of a purification of the nitric acid in the first to ninth examples;

FIG. 5 is a drawing illustrating a result of purification of the nitric acid in the first to fifth examples and in first to fourth comparative examples; and

FIG. 6 is a drawing illustrating a result of the purification of the nitric acid in sixth to ninth examples and in a fifth comparative example.

### DETAILED DESCRIPTION

Embodiments of a purification catalyst according to the present disclosure will be described.

A catalyst particle is made from a metal oxide that has a function of an n-type semiconductor. The n-type semiconductor corresponds to a semiconductor in which a free electron is used as a carrier that transports an electric charge. The metal oxide corresponds to, for example, titanium oxide, complex oxide including titanium, nitride including titanium, tungsten oxide, zinc oxide, gallium phosphide, gallium arsenic.

When the metal oxide corresponds to the titanium oxide, a type of the titanium oxide may be amorphous. More preferably, the titanium oxide corresponds to a rutile-type titanium oxide, an anatase-type titanium oxide, or a mixture of the rutile-type titanium oxide and the anatase-type titanium oxide. In this case, it may be possible to improve a purification rate of the nitric acid.

A surface of the catalyst particle may support metal. In this case, it may be possible to improve a catalytic activity of the purification catalyst and to purify the nitric acid at higher purification rate. The metal, which is supported on the surface of the catalyst particle, is at least one selected from a group consisting of Pd, Ag, Ru, Rh, Pt, Au, Ir, Ni, Fe, Cu, and Cr, for example.

An inorganic acid corresponds to, for example, perchloric acid, phosphoric acid, nitric acid, sulfuric acid, perbromic acid, periodic acid, silicic acid, carbonic acid, or the like. It may be preferable that a pKa value of the inorganic acid is equal to or less than 5. Preferably, the pKa value may be equal to or less than 0. In this case, it may be possible to improve the purification rate of the nitric acid and to further reduce the generation amount of ammonia.

The purification catalyst is used under a light irradiation condition, a heating condition, or the light irradiation-and-heating condition. It may be preferable that at least one of visible light and ultraviolet rays are irradiated to the purification catalyst. In this case, it may be possible to further improve the purification rate of the nitric acid.

That is, the purification catalyst includes the catalyst particle made from the metal oxide, the inorganic acid, and water. It may be preferable that the inorganic acid is ionized in water. A nature of the purification catalyst corresponds to a dispersed state in which the catalyst particle is dispersed in water dissolving the inorganic acid, an infiltration state in which the water dissolving the inorganic acid infiltrates a powder of the catalyst particle, or another state in which the water dissolving the inorganic acid is impregnated with a porous body and the catalyst particle is supported by the porous body, for example.

The purification catalyst is used for a purification of material including the nitric acid. For example, the purification catalyst is used for purifying the nitric acid that is included in wastewater from a factory or the like. More specifically, the purification catalyst may be used for purifying nitrate ion.

### EXAMPLES

### First Example

Followingly, examples purifying the nitric acid with the purification catalyst in the present disclosure will be explained.

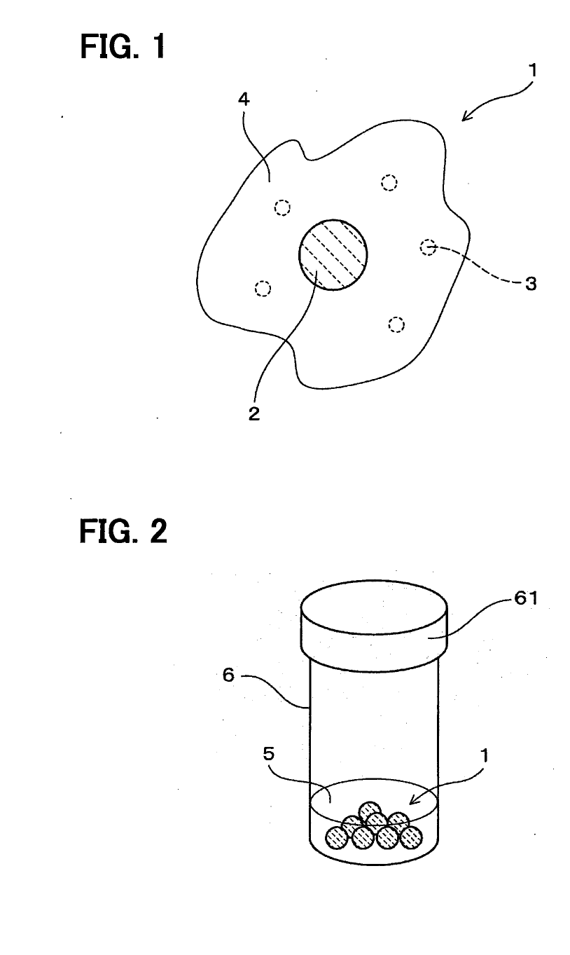

The purification catalyst in the present example purifies the nitric acid. As described in FIG. 1, a purification catalyst 1 includes a catalyst particle 2, an inorganic acid 3, and water 4. The purification catalyst 1 is used under a light irradiation condition, a heating condition, or a light irradiation-and-heating condition. In the present example, the catalyst particle 2 corresponds to a titanium oxide particle, and the inorganic acid 3 corresponds to perchloric acid.

The purification catalyst 1 is produced by the following manner. Specifically, a titanium oxide particle of 10 mg is inputted to a 5 ml sample tube made of quartz initially. An example of the titanium oxide particle corresponds to AEROXIDE (a registered trademark) TiO₂ P25 produced by NIPPON AEROSIL CO., LTD. The titanium oxide particle in the present example has an average particle diameter of 20 nm and a mixture of a rutile-type and an anatase-type titanium oxide. Incidentally, the average particle diameter represents a particle size with 50% volume integrated value of size distribution calculated with a laser diffraction-scattering method.

Next, a 13 mg water solution of perchloric acid (HClO₄) of a concentration 60 wt % is added into the sample tube. According to the above manner, the purification catalyst 1 including the catalyst particle 2 made from titanium oxide, the inorganic acid 3 made from perchloric acid, and water 4 is obtained. In the purification catalyst 1 in the present example, a ratio of the mass of an inorganic acid to the mass of a catalyst particle is equal to 0.8.

As described in FIG. 2, a nitric acid 5 of a concentration 65 wt % is added to the purification catalyst 1 in the sample tube 6. The adding amount of the nitric acid is equal to 1 μL. Dispersion treatment is performed to the mixture in the sample tube 6 with an ultrasonic washing machine for 5 minutes. An opening of the sample tube 6 is covered with an airtight stopper 61 and the inside of the sample tube 6 is sealed. Light of 250-400 nm in wavelength is irradiated from the below of the sample tube 6 for 24 hours. The nitric acid in the sample tube 6 is purified by the purification catalyst 1. Incidentally, a xenon lamp PU-21 made by TOPCON TECHNOHOUSE CORP. is used for light irradiation.

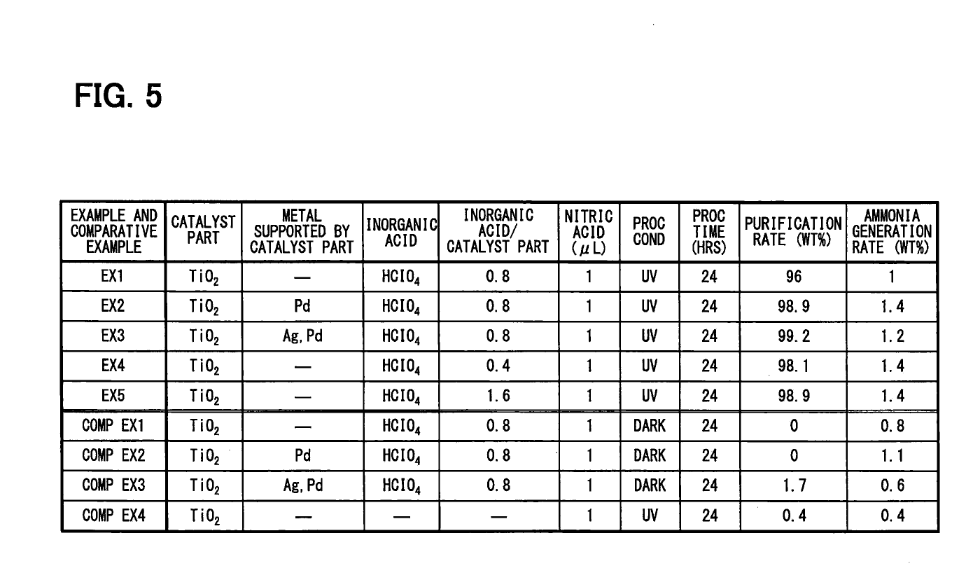

Distilled water is added into the sample tube 6 so that the total volume is adjusted to 5 ml. Accordingly, a generated ammonia accompanied with the purification of the nitric acid is dissolved into water. Concentrations of nitrate ion and ammonium ion included in a solution in the sample tube 6 are measured. In order to detect the concentrations, an ion chromatography is performed with ICS-1500 made by NIPPON DIONEX K. K. After the detection, a purification rate of nitric acid is calculated from the concentration of the nitrate ion before/after the nitric acid purification. In addition, the concentration of the ammonium ion after purification is defined as an ammonia generation rate. FIG. 5 illustrates a result.

### Second Example

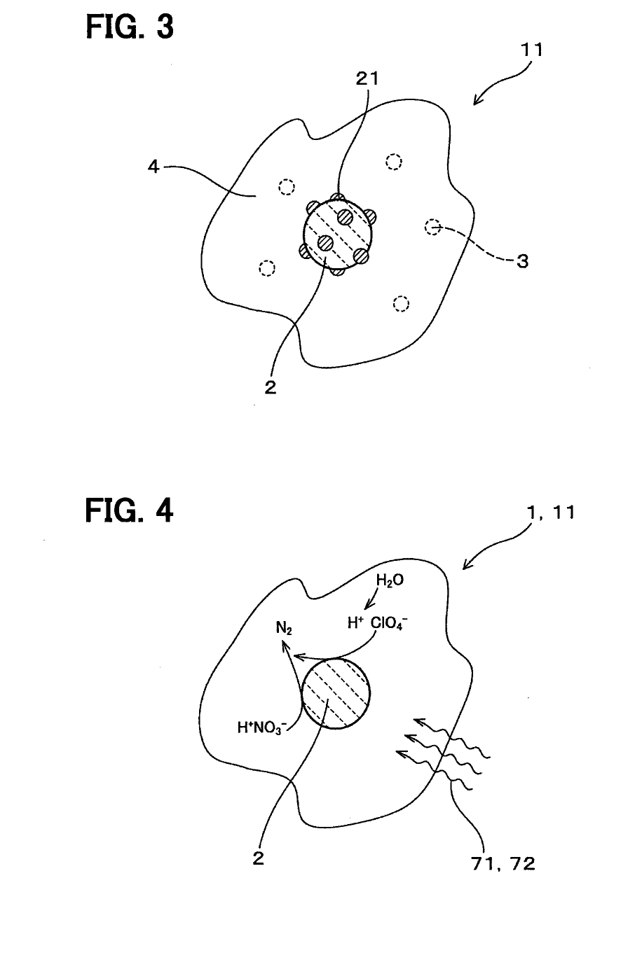

A purification catalyst 11 in a second example includes a catalyst particle whose surface supports noble metal and purifies the nitric acid. As described in FIG. 3, the purification catalyst 11 in the second example includes a catalyst particle 2 that supports a noble metal 21, the inorganic acid 3, and water 4. In the present example, the noble metal 21 corresponds to Pd. The purification catalyst 11 in the present example is produced similar to the first example, except that the titanium oxide particle of 10 mg to a surface of which Pd is attached. Pd is attached to a surface of the titanium oxide particle by a photoelectric deposition method.

Specifically, a mixture solvent is produced by mixing 40 ml pure water and 10 ml ethanol in a beaker. The titanium oxide of 0.25 g, which is similar to the first example, is dispersed into the mixture solvent. After the dispersion, Pd(NO₃)₃ is dissolved in the mixture solvent. The adding amount of Pd(NO₃)₃ is equal to 0.5 mol per 100 mol titanium oxide.

Light of 250-400 nm in wavelength is irradiated from the above of the beaker for 3 hours while mixing the mixture solvent in the beaker. Incidentally, a xenon lamp similar to the first example is used for light irradiation. As a result, according to a photoelectrical deposition method, a fine particle made from Pd is deposited to the surface of the titanium oxide particle. The mixture solvent in the beaker is dried up at 80 degrees Celsius. The titanium oxide particle whose surface is attached with Pd is obtained. The titanium oxide particle whose surface is attached with Pd corresponds to the catalyst particle 2 that the noble metal 21 is supported (referring to FIG. 3).

The purification catalyst 11 is produced similar to the first example, except that the 10 mg catalyst particle 2 supporting the noble metal 21 is used (referring to FIG. 3). Similar to the first example, the purification of the nitric acid is performed using the purification catalyst 11. FIG. 5 illustrates the result. Incidentally, in the second example, a symbol identical with the symbol in the first example represents the identical configuration with the first example, and the explanations in the preceding will be referred.

### Third Example

The purification catalyst in the third example includes a catalyst particle supporting Ag and another catalyst particle supporting Pd. A production of the purification catalyst in the third example will be explained. Similar to the second example, a titanium oxide particle supporting Pd is produced initially. Next, as described below, a titanium oxide particle supporting Ag is produced.

Specifically, a mixture solvent is produced by mixing 40 ml pure water and 10 ml ethanol in a beaker initially. Titanium oxide of 0.25 g, which is similar to the first example, is dispersed into the mixture solvent. Then, Ag₂O is added into the mixture solvent. The adding amount of Ag₂O corresponds to 0.5 mol per 100 mol titanium oxide.

Light of 250-400 nm in wavelength is irradiated from the above of the beaker for 3 hours while mixing the mixture solvent in the beaker. Incidentally, a xenon lamp similar to the first example is used for light irradiation. As a result, according to a photoelectrical deposition method, a fine particle made from Ag is deposited to the surface of the titanium oxide particle. The mixture solvent in the beaker is dried up at 80 degrees Celsius. Accordingly, the titanium oxide particle whose surface is attached with Ag is produced.

A purification catalyst is produced similar to the first example, except that the titanium oxide particle of 5 mg supporting Pd and the titanium oxide particle of 5 mg supporting Ag are used. Similar to the first example, the purification of the nitric acid is performed using the purification catalyst. FIG. 5 illustrates the result.

### Fourth Example and Fifth Example

The fourth example and the fifth example is an example of a purification catalyst produced similar to the first example except that the adding amount of the inorganic acid is changed to the catalyst particle.

In the purification catalyst in the fourth example, a ratio of a mass of the inorganic acid to a mass of the catalyst particle is equal to 0.4. In the purification catalyst in the fifth example, a ratio of a mass of the inorganic acid to a mass of the catalyst particle is equal to 1.6. Other configurations are similar to the first example. Similar to the first example, the purification of the nitric acid is performed using each of the purification catalysts. FIG. 5 illustrates the result.

### First to Third Comparative Examples

In the above examples, the purification of the nitric acid is performed by irradiating ultraviolet rays, that is, light of 250-400 nm in wavelength. The present comparative examples perform a purification of the nitric acid in a darkroom without irradiation of light.

In the first comparative example, the purification of the nitric acid is performed similar to the first example, except that the purification of the nitric acid is performed in a darkroom. In the second comparative example, the purification of the nitric acid is performed similar to the second example, except that the purification of the nitric acid is performed in a darkroom. In the third comparative example, the purification of the nitric acid is performed similar to the third example, except that the purification of the nitric acid is performed in a darkroom. Results of the purification of the nitric acid in the first to third comparative examples will be illustrated in FIG. 5.

### Fourth Comparative Example

In the fourth comparative example, the purification of the nitric acid is performed without an inorganic acid. Specifically, the purification catalyst is produced similar to the first example, except that an inorganic acid is not added. Then, similar to the first example, the purification of the nitric acid is performed using the purification catalyst. FIG. 5 illustrates the result.

### Sixth to Eighth Examples

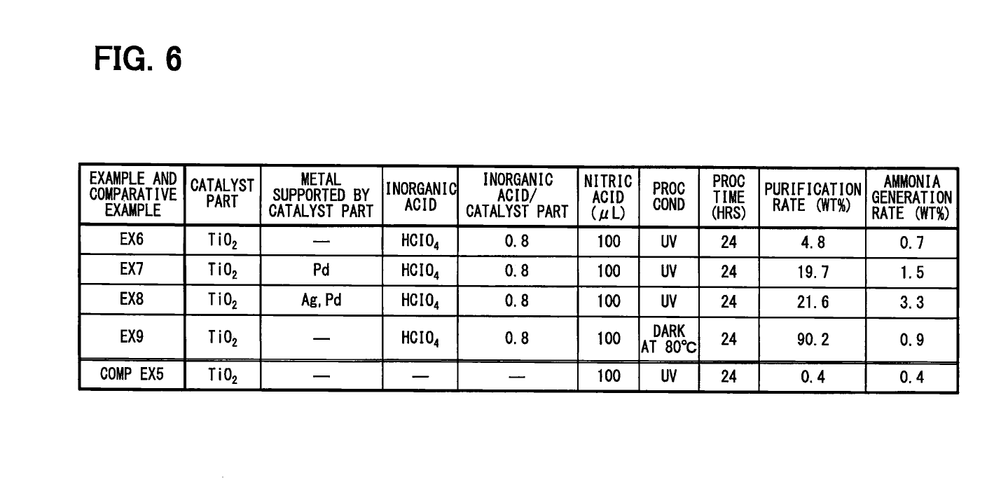

In the sixth to eight examples, the amount of the nitric acid is changed, and the purification of the nitric acid is performed. In the sixth to eighth examples, the purification of the nitric acid is performed similar to the first to third examples, except that the adding amount of the nitric acid is changed to 100 μL. FIG. 6 illustrates the result.

### Ninth Example

In the ninth example, the purification of the nitric acid is performed under a heating condition. Specifically, in the present example, the purification of the nitric acid is performed in a darkroom under a heating condition of 80 degrees Celsius without light irradiation. In addition, the nitric acid of 100 μL is used in the present example. The purification of the nitric acid is performed similar to the first example with respect to other points. FIG. 6 illustrates the result.

### Fifth Comparative Example

In the fifth comparative example, the amount of the nitric acid is changed, and the purification of the nitric acid is performed without using the inorganic acid. Specifically, the purification catalyst is produced similar to the first example, except that an inorganic acid is not added. Then, the purification of the nitric acid is performed similar to the first example, except that the purification catalyst is used and the adding amount of the nitric acid is changed to 100 μL. FIG. 6 illustrates the result

### Comparison Between Examples and Comparative Examples

FIG. 5 and FIG. 6 illustrate results of the examples and the comparative examples.

As described in FIG. 5 and FIG. 6, the purification catalysts 1, 11 in the first to ninth examples, which include the catalyst particle 2, the inorganic acid 3 and water 4, enables to purify the nitric acid at high purification rate by light irradiation or heating (referring to FIG. 1 and FIG. 3). The generation ratio of the ammonia during the purification of the nitric acid is kept low in the first to ninth examples. As described in FIG. 5 and FIG. 6, irrespective of the amount of the nitric acid, it is possible that the purification catalyst in the first and ninth examples purifies the nitric acid at high purification rate compared with the comparative examples and the generation rate of the ammonia is kept low. Therefore, it is possible to purify the nitric acid sufficiently while preventing the generation of the ammonia by the purification catalyst in the first to ninth examples under at least one of the light irradiation condition and the heating condition.

FIG. 4 illustrates a mechanism of nitric acid purification by the purification catalyst in the first to ninth examples. As described in FIG. 4, in the purification catalysts 1, 11, the catalyst particle 2 made from metal oxide, which has a function of an n-type semiconductor, is activated by light 71 or heat 72. Then, the activated catalyst particle 2 and the inorganic acid (corresponding to HCl₄) generate hydrogen ion (H⁺) from water (H₂O). A nitrate ion (NO₃⁻) is purified by the hydrogen ion and nitrogen gas (N₂) is generated. That is, the purification catalysts 1, 11 reduce the nitric acid so that water including nitric acid is purified. The purification catalysts 1, 11 purify the nitric acid at a high purification rate under the presence of at least one of light 71 and heat 72. It is possible that the purification catalysts 1, 11 prevent the generation of the ammonia at the time of the purification of nitric acid.

It may be preferable that the metal oxide configuring the catalyst particle 2 corresponds to titanium oxide (referring to FIG. 1 and FIG. 3). In this case, it may be possible to purify the nitric acid sufficiently as described in the present disclosure. Any kind of complex oxide of titanium with a function of an n-type semiconductor, as with the titanium oxide, may have similar effects to the first to ninth examples.

It may be preferable that the inorganic acid 3 corresponds to perchloric acid. In this case, it is possible to further increase the purification rate of the nitric acid and to reduce the generation amount of the ammonia.

As described in FIG. 5, effects (e.g., increase of the purification rate of the nitric acid) matching the adding amount of the inorganic acid 3 may not be obtained even when the amount of the inorganic acid 3 is increased to a predetermined volume or more. Thus, it may be preferable that a containing ratio of the inorganic acid 3 to the catalyst particle 2 is equal to 1 or less in the mass ratio. In addition, it may be preferable that the containing ratio of the inorganic acid 3 to the catalyst particle 2 is equal to 0.1 or more in the mass ratio to sufficiently obtain addition effects of the inorganic acid 3.

It may be preferable that the surface of the catalyst particle 2 supports the noble metal 21. In this case, it may be possible to improve the purification rate of the nitric acid.

It may be preferable that the purification catalysts 1, 11 are used under at least the irradiation condition of ultraviolet rays. In this case, it may be possible to improve the purification rate of the nitric acid. It may be preferable that the purification catalysts 1, 11 are used under at least the heating condition. In this case, it may be possible to improve the purification rate of the nitric acid. A temperature in the heating condition may correspond to approximately 80 degrees Celsius. In other words, 80 degrees Celsius may be enough for the heating condition. Thus, it may be possible to realize the heating condition using waste heat. It may be preferable that the heat temperature is equal to 40 degrees Celsius or more. More preferably, the heated temperature may be equal to 50 degrees Celsius. Considering a use of waste heat, it may be preferable that the heated temperature is equal to 100 degrees Celsius or less. More preferably, the heated temperature is equal to 90 degrees Celsius or less.

According to one aspect of the present disclosure, a purification catalyst purifying nitric acid is provided. The purification catalyst includes a catalyst particle made from metal oxide with a function of an n-type semiconductor, inorganic acid, and water. The purification catalyst is used under at least one of a light irradiation condition and a heating condition.

The catalyst particle, which is made from the metal oxide with the function as the n-type semiconductor in the purification catalyst, is activated under the light irradiation conditions and/or the heating condition. Atomic hydrogen is generated by the activated catalyst particle and the inorganic acid. The nitric acid is reduced by the atomic hydrogen so that nitrogen gas is generated. Accordingly, it is possible that the purification catalyst purifies the nitric acid. Furthermore, the hydrogen atom in the inorganic acid, which has been consumed by a reduction of the nitric acid, is filled by a proton in water.

According to the purification catalyst in the present disclosure, it may be possible that the purification catalyst purifies the nitric acid at a high purification rate under at least one of the light irradiation condition and the heating condition (corresponding to the light irradiation condition, the heating condition, or the light irradiation-and-heating condition). In addition, it is possible that the purification catalyst prevents generation of the, ammonia at the time of the purification of the nitric acid.

In addition, the purification catalyst does not include an organic substance at a constituent. Therefore, it is unlikely that an organic substance is decomposed by a light irradiation or heating. Therefore, the catalyst activity may be hardly reduced by the light irradiation or heating. Therefore, it may be possible that the purification catalyst purifies the nitric acid at the high purification rate even under the light irradiation condition, the heating condition, or the light irradiation-and-heating condition. In addition, it may be possible to purify the nitric acid under an atmospheric environment especially without making a reduction atmosphere.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A purification catalyst that purifies nitric acid comprising:
a catalyst particle including a metal oxide that has a function of an n-type semiconductor;
an inorganic acid; and
water, wherein
the purification catalyst purifies the nitric acid under at least one of a light irradiation condition and a heating condition.

2. The purification catalyst according to claim 1, wherein
the metal oxide corresponds to
titanium oxide,
a complex oxide including titanium, or
the titanium oxide and the complex oxide including the titanium.

3. The purification catalyst according to claim 1, wherein
the inorganic acid corresponds to perchloric acid.

4. The purification catalyst according to claim 1, wherein
a containing ratio of the inorganic acid to the catalyst particle is equal to 1 or less in mass ratio.

5. The purification catalyst according to claim 1, wherein
a surface of the catalyst particle supports a noble metal.

6. The purification catalyst according to claim 1, wherein
the purification catalyst is used at least under the light irradiation condition of ultraviolet rays.

7. The purification catalyst according to claim 1, wherein
the purification catalyst is used at least under the heating condition.

8. The purification catalyst according to claim 1, wherein
the metal oxide corresponds to at least one of a rutile-type titanium oxide and an anatase-type titanium oxide, and
the inorganic acid corresponds to perchloric acid.

9. The purification catalyst according to claim 8, wherein a surface of
the catalyst particle supports Pd.

10. The purification catalyst according to claim 9, wherein
the surface of the catalyst particle further supports Ag.
